(19) United States
(12) Patent Application Publication
(10) Pub. No.: US 2016/0112147 A1
(43) Pub. Date: Apr. 21, 2016

(54) RECEIVER AND BEAM SPACE SAMPLING METHOD THEREOF

(71) Applicant: Electronics and Telecommunications Research Institute, Daejeon (KR)

(72) Inventors: Seok SEO, Daejeon (KR); Seung-Hwan LEE, Daejeon (KR)

(73) Assignee: Electronics and Telecommunications Research Institute, Daejeon (KR)

(21) Appl. No.: 14/680,780

(22) Filed: Apr. 7, 2015

(30) Foreign Application Priority Data
Oct. 20, 2014 (KR) 10-2014-0141531

(51) Int. Cl. H04B 17/20; H04B 1/12; H04B 7/06; H04L 27/26

(52) U.S. Cl. CPC H04B 17/20; H04L 27/2649; H04B 1/123; H04B 7/0617

(57) ABSTRACT

Provided is a beam space sampling method of a receiver including an antenna including an active element and at least one parastic element. The beam space sampling method includes: varying a reactance value of the parasitic element to receive RF signals corresponding to beam patterns; measuring the quality of the received signal corresponding respectively to the beam patterns; and selecting beam patterns providing the signal quality equal to or higher than a threshold value.

### CROSS-REFERENCE TO RELATED APPLICATIONS

This U.S. non-provisional patent application claims priority under 35 U.S.C. §119 of Korean Patent Application No. 10-2014-0141531, filed on Oct. 20, 2014, the entire contents of which are hereby incorporated by reference.

### BACKGROUND OF THE INVENTION

The present invention disclosed herein relates to a communication system, and more particularly, to a beam space sampling based receiver and a beam space sampling method thereof.

A plurality of transmission signals may be received by a plurality of different antennas, experiencing spatially independent fading in a wireless channel. In this case, there is non-correlation between signals received by antennas. A multiple input multiple output (MIMO) technology has been proposed, which may simultaneously transmit a plurality of independent data symbols by using the same frequency at the same time by using an array antenna by using such a non-correlation. In principle, the wireless channel capacity of a MIMO system increases in direct proportion to the number of antennas. Thus, the MIMO technology is taking the center stage as a wireless transmission technology that may dramatically increase the usage efficiency of a limited frequency resource.

However, a distance between antennas needs to be equal to or larger than the half of a carrier wavelength (λ/2 where λ indicates a wavelength) in order to maintain the non-correlation between MIMO channel paths. Therefore, there is a limitation in increasing the number of the antennas, due to a spatial constraint. Moreover, a receiver needs independent radio frequency (RF) chains for each data symbol in proportion to the number of antennas. In order to include the plurality of antennas, not only a manufacturing cost increases, but also power consumption of a circuit. Thus, a limited number of multiple antennas are being used in an actual MIMO system.

Furthermore, when a plurality of antennas is disposed in a narrow space, the spatial correlation between signals transmitted through antennas increases because a distance between the antennas decreases. In addition, since the coupling between the antennas increases, multiplexing gain performance may be degraded. Also, since independent RF chains corresponding to the number of antennas are needed, the price, complexity and power consumption of a device employing the MIMO technology increase. Thus, there is a limitation in applying the MIMO technology to a user terminal, such as a smart phone, sensitive to a size and power consumption.

Recently, a sampled rotating antenna (SRA) technique has been proposed, which obtains a multiplexing gain by using one active antenna and one or more parasitic elements. The SRA technique provides the multiplexing gain by time-dividing one symbol section, changing the directionality of an antenna beam, and performing a beam space sampling. However, there is a limitation in that it is difficult to maximize the multiplexing gain due to the absence of a method of determining the optimal directionality of a beam.

### SUMMARY OF THE INVENTION

The present invention provides a receiver that may determine the optimal beam patterns maximizing a multiplexing gain in an antenna structure with one active antenna and one or more parasitic elements, and a method of determining the beam patterns thereof.

Embodiments of the present invention provide beam space sampling methods of a receiver including an active element and at least one parasitic element, the beam space sampling method including: varying a reactance value of the parasitic element to receive RF signals corresponding to different beam pattern; measuring quality of a signal received from respective beam patterns; and selecting beam patterns referring to signal quality.

In other embodiments of the present invention, receivers include: an antenna including an active element and at least one parasitic element with a variable reactance for beam steering; a single radio frequency (RF) chain demodulating a received signal; a signal quality meter measuring a quality of a received signal; and a threshold value comparator selecting beam patterns referring to signals quality.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a block diagram of a receiver according to a first embodiment of the present invention;

FIG. 2 exemplarily shows an antenna structure with one active antenna and one or more parasitic elements, for beam steering in FIG. 1;

FIG. 3 exemplarily shows a beam pattern in an antenna structure in FIG. 2;

FIG. 4 is a flowchart of a beam space sampling method according to a receiver in FIG. 1;

FIG. 5 is a block diagram of a receiver according to a second embodiment of the present invention; and

FIG. 6 is a flowchart of a beam space sampling method according to a receiver in FIG. 5.

### DETAILED DESCRIPTION OF PREFERRED EMBODIMENTS

The above general descriptions and the following detailed descriptions all are exemplary for providing additional descriptions for the claimed invention. Therefore, the present invention is not limited to embodiments to be described below but may be implemented in other forms. Exemplary embodiments introduced herein are provided to make disclosed contents thorough and complete and to fully convey the spirit of the present invention to a person skilled in the art.

The terms used herein are only used to describe specific embodiments and not intended to limit the present invention. The terms in singular form include the plural form unless otherwise specified. It should be understood that the terms “includes” or “has” indicate the presence of characteristics, numbers, steps, operations, components, parts or combinations thereof represented in the present disclosure but do not exclude the presence or addition of one or more other characteristics, numbers, steps, operations, components, parts or combinations thereof.

Unless otherwise defined herein, all terms used herein including technical or scientific terms have the same meanings as those generally understood by a person skilled in the art. Terms defined in generally used dictionaries should be construed to have meanings matching with contextual meanings in the related art and are not construed as an ideal or excessively formal meaning unless otherwise defined herein.

When the present disclosure mentions that any part includes any component, it means that it is also possible to further include other components. Also, each embodiment described and illustrated herein includes its complementary embodiment. Embodiments of the present invention are described below in detail with reference to the accompanying drawings.

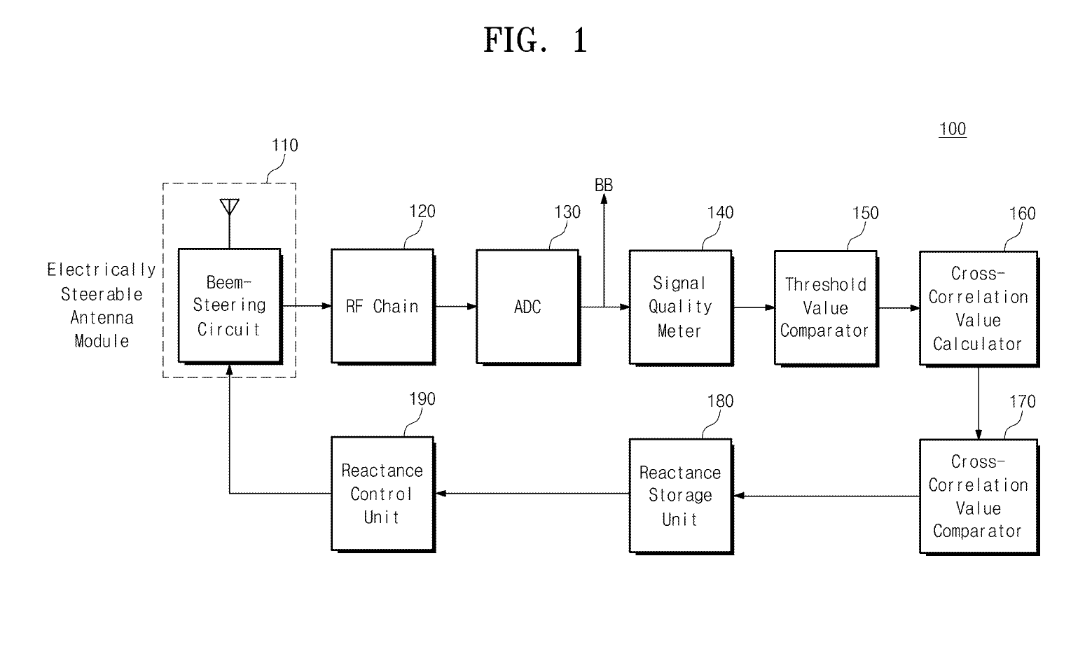

FIG. 1 is a block diagram of a receiver performing beam space sampling of the present invention. Referring to FIG. 1, a receiver 100 of the present invention may include a electrically steerable antenna module 110, a radio frequency (RF) chain 120, an analog to digital converter (ADC) 130, a signal quality meter 140, a threshold value comparator 150, a cross-correlation value calculator 160, a cross-correlation value comparator 170, a reactance storage unit 180, and a reactance control unit 190.

The electrically steerable antenna module 110 includes an active element and at least one parasitic element and may provide a various beam patterns. The reactance value of the parasitic element may be variable, and a beam-steering circuit may include a variable reactance device or a switch. The electrically steerable antenna module 110 may electrically control a beam pattern by electrically varying the reactance value of the parasitic element. The active element may transmit or receive an RF signal, like a monopole antenna or dipole antenna. The present disclosure mainly describes a receiver technology. Thus, a signal received through the active element is transmitted to the RF chain 120. On the contrary, a plurality of parasitic elements has a variable reactance load, respectively. Each reactance load value may vary by the reactance control unit 190. Due to the above-described structure, the electrically steerable antenna module 110 may electrically steer beam pattern by controlling the reactance load value. Through electrical beam-steering, it is possible to provide a diversity effect or multiplexing gain through a single active antenna.

The RF chain 120 amplifies and filters a signal received through the active element. And an amplified and filtered signal is transmitted to the ADC 130. In this example, the RF chain 120 may include a duplexer, a low noise amplifier (LNA), a band pass filter, and a mixer, for example. However, it is well understood that the configuration of the RF chain 120 is not limited thereto and its detailed components may be added or changed according to a communication scheme.

The ADC 130 converts an analog signal demodulated by the RF chain 120 into a digital signal. That is, an analog signal provided from the RF chain 120 is sampled and converted into a baseband digital signal by the ADC 130. The ADC 130 may be provided as a flash ADC, a pipeline ADC, or a successive approximation ADC, for example. A digital signal obtained by the ADC 130 is transmitted to a baseband processing unit (not shown). In addition, a digital signal output from the ADC 130 is also transmitted to the signal quality meter 140 for the electrical beam-steering of the present invention.

The signal quality meter 140 measures the quality of the digital signal from the ADC 130. That is, the signal quality meter 140 may measure the quality of a signal received from a different beam pattern. The signal quality may be measured in the magnitude, strength, power, signal to noise ratio (SNR), signal to interference and noise ratio (SINR), and error rate of the received signal, for example.

The threshold value comparator 150 compares the qualities of a signal received from a different beam pattern with a pre-defined threshold value. And the threshold value comparator 150 selects signals with signal quality equal to or higher than a threshold value among the received signals corresponding to beam patterns. In addition, the threshold value comparator 150 detects beam patterns corresponding respectively to selected signals. It is also possible to store with beam pattern index corresponding to each of detected beam patterns.

The cross-correlation value calculator 160 calculates the cross-correlation values between beam patterns providing signal qualities equal to or higher than the threshold value. The cross-correlation value calculator 160 may calculates the cross-correlation values between received signals with signal quality equal to or higher than the threshold value. The respective cross-correlation values may be provided to the cross-correlation value comparator 170.

The cross-correlation value comparator 170 compares the cross-correlation values between beam patterns or received signals providing signal quality equal to or higher than the threshold value. And the cross-correlation value comparator 170 selects beam patterns having a relatively low cross-correlation among the cross-correlation values. For example, the cross-correlation value comparator 170 may select N beam patterns having a low cross-correlation value. The reactance information corresponding to each of selected beam patterns may be stored in the reactance storage unit 184.

The reactance storage unit 180 stores the reactance information on N beam patterns having a signal quality equal to or higher than a threshold value and a cross-correlation value smaller than a reference value. For example, reactance index or reactance values corresponding to beam patterns capable of maximizing the multiplexing gain may be stored in the reactance storage unit 180.

The reactance control unit 190 controls the electrically steerable antenna module 110 to configure the beam pattern of an antenna. That is, the reactance control unit 190 may enable the antenna to steer in all beam patterns during beam pattern searching. On the contrary, after the reactance information on N beam patterns having a signal quality equal to or higher than a threshold value and a cross-correlation value smaller than a reference value is stored in the reactance storage unit 180, the reactance control unit 190 controls the electrically steerable antenna module 110 so that the antenna electrically steers in N beam patterns. For the beam-steering, the reactance control unit 190 outputs a reactance control signal LCn for varying the reactance value of the parasitic element.

According to the receiver of the present invention as described above, the received signal qualities corresponding to beam patterns are measured and beam patterns with high signal quality are selected. In addition, cross-correlation values between beam patterns or received signals providing a high signal quality are calculated, and beam patterns providing low cross-correlation values are selected. Performing the beam space sampling with beam patterns selected by using this method may provide the maximum multiplexing gain.

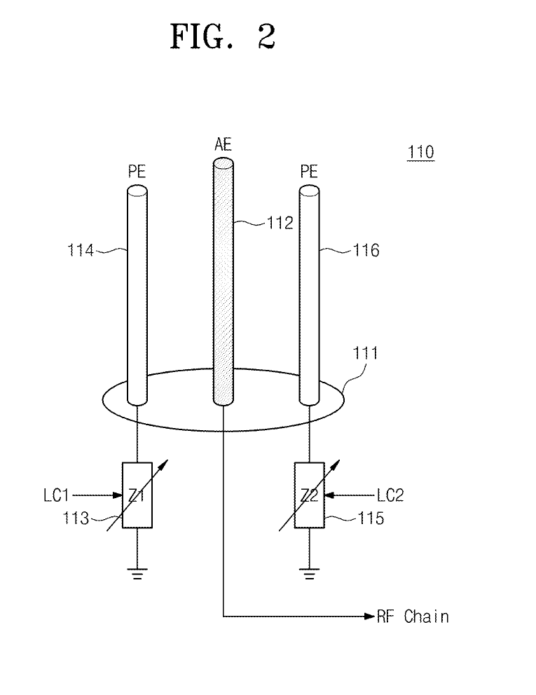

FIG. 2 exemplarily shows the electrically steerable antenna module 110 of the present invention as shown in FIG. 1. The electrically steerable antenna module 110 may include an active element 112 and, parasitic elements 114 and 116, and variable reactances 113 and 115 for changing the reactance value of the parasitic elements 114 and 116.

The electrically steerable antenna module 110 receives an RF signal through the active element 112. The RF signal is received by the active element 112 and transmitted to the RF chain 120. In this case, the beam-steering of the electrically steerable antenna module 110 is achieved through the control of the variable reactances 113 and 115. By controlling the value of the variable reactances 113 and 115, it is possible to provide a multiplexing effect from a signal received through only one active element 112.

The value of the reactance 113 or 115 may set to all beam patterns available for the optimal beam pattern search. However, after the optimal beam pattern search is completed, the value of the reactance 113 or 115 may be changed to reactance values corresponding to information stored in the reactance storage unit 180. Performing the beam space sampling through this method may provide the maximum multiplexing gain.

In this example, the active element 112 may include a dipole antenna or monopole antenna. In addition, the reactances 113 and 115 may include a variable reactance that vary by the reactance control signal LCn provided by the reactance control unit 190. That is, the reactances 113 and 115 may include a varactor. In addition, the reactances 113 and 115 may also include a pin diode or micro electro mechanical system (MEMS) switch when they are formed in a simple switching structure.

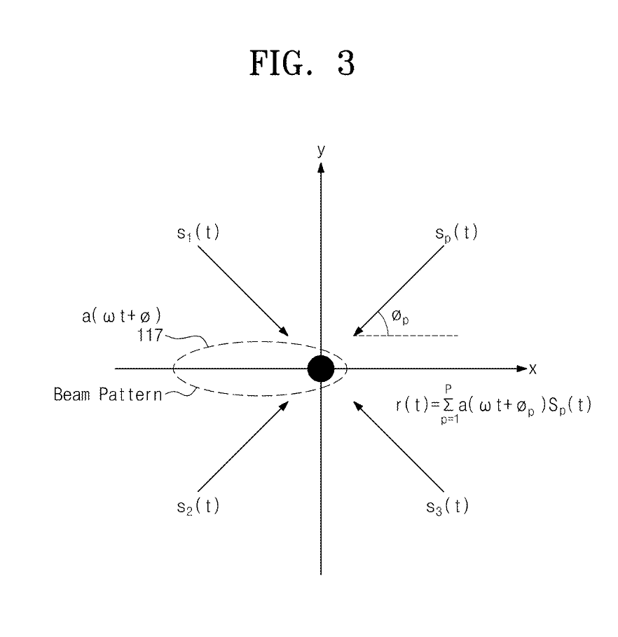

FIG. 3 exemplarily shows a change in a beam pattern in an antenna structure in FIG. 2. Referring to FIG. 3, the electrically steerable antenna module 110 receives an RF signal sₚ(t) in various directions. In this case, any RF signal sₚ(t) is an RF signal received at an azimuth angle φₚ. Such RF signals are received by the active element 112 of the antenna at different intensities in various directions.

If P RF signals are provided to the electrically steerable antenna module 110 in various directions, the received signal r(t) received at a time point t may be represented by Equation 1 below:

$$r ( t ) = {\sum }_{p = 1}^{P} a ( ω t + {φ}_{s} ) {s}_{p} ( t ) \qquad 〈 Equation 1 〉$$

where P denotes the number of signals received by the active element 112 of the antenna in various directions and a(ωt+φₚ) denotes an antenna pattern function of the electrically steerable antenna module 110.

According to Equation 1 above, the received signal r(t) received by the electrically steerable antenna module 110 may be given by a weighted sum of RF signals received in various directions by multiple path fading and the antenna pattern function of the electrically steerable antenna module 110.

The electrically steerable antenna module 110 may electrically vary the reactance value of the parasitic element to control a beam pattern. In order to obtain a multiplexing gain by using the electrically steerable antenna module 110, there is a need to divide one symbol duration into a plurality of time slot, and perform beam space sampling by varying beam pattern at every time slot. The quality of the received signal r(t) depends on the antenna beam pattern. The signal quality may be measured in the magnitude, strength, power, signal to noise ratio (SNR), signal to interference and noise ratio (SINR), and error rate, etc. Thus, in order to enhance the multiplexing gain, there is a need for a method of determining the optimal beam pattern.

The receiver 100 of the present invention may search the optimal beam pattern that may maximize the multiplexing gain by using the electrically steerable antenna module 110. In addition, it is possible to provide an optimal multiplexing gain by setting the electrically steerable antenna module 110 sequentially in searched beam patterns.

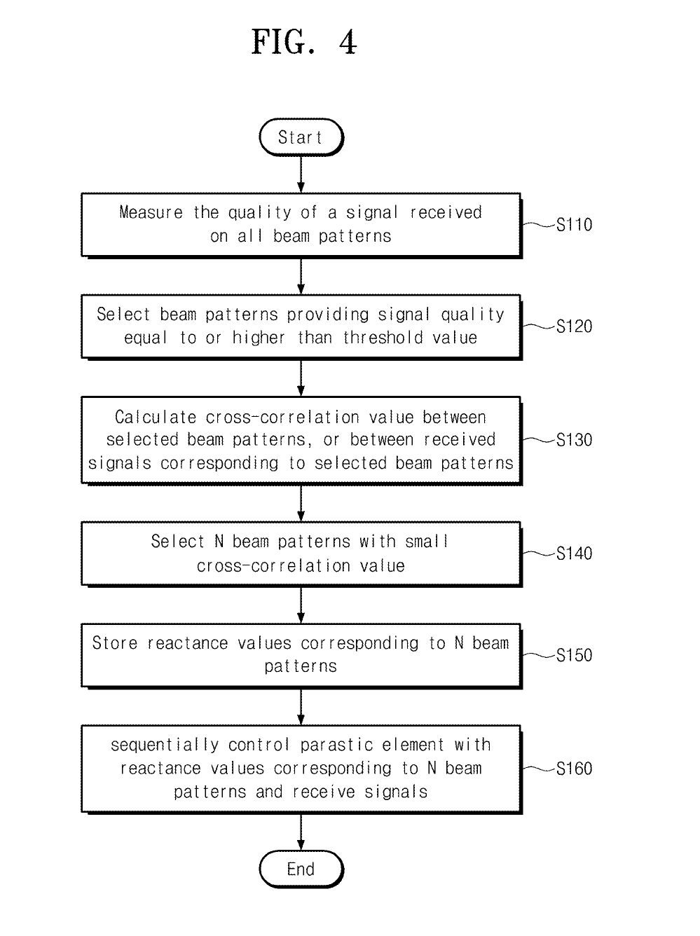

FIG. 4 is a flowchart of a beam space sampling method according to the receiver in FIG. 1.

In step S110, the receiver 110 measures the quality of the signal received from all beam patterns. For example, at least one of the magnitude, strength, power, signal to noise ratio (SNR), signal to interference and noise ratio (SINR), and error rate of signals received from all available beam patterns are measured by the signal quality meter 140. Firstly, the reactance controller 190 enables the reactance of the electrically steerable antenna module 110 to be reactance values corresponding to all beam patterns to be measured. By such reactance control, the electrically steerable antenna module 110 may radiates a different beam patterns. The signal quality of each of signals received in from respective beam patterns is measured by the signal quality meter 140.

In step S120, the receiver 100 detects a beam patterns providing a signal quality equal to or higher than a threshold value, referring to the quality of signal received from each beam pattern. The operation of detecting the beam pattern providing a signal quality equal to or higher than the threshold value may be performed by the threshold value comparator 150.

In step S130, the receiver 100 calculates the cross-correlation value between beam patterns selected by the threshold value comparator 150. Or in step S130, the receiver 100 may calculates the cross-correlation value between received signals corresponding to beam patterns selected by the threshold value comparator 150. The cross-correlation value between the beam patterns may be calculated on all beam patterns providing a signal quality equal to or higher than the threshold value. The cross-correlation value between the beam patterns may be represented by Equation 2 below:

Rᵢⱼ=∫ₒ^{2π}Φᵢ(ψ)Φ*ⱼ(ψ)dψ, ∀i,j, i≠j <Equation 2>

where ψ denotes an azimuth angle, Φi(ψ) and Φj(ψ) means an ith and jth beam pattern respectively, providing a signal quality equal to or higher than the threshold value, and Φi*(ψ) means a complex conjugation of Φj(ψ). The cross-correlation value calculator 160 calculates a cross-correlation value Rᵢⱼ given by Equation 2 for all i and j (i≠j).

In step S140, the receiver 100 selects N beam patterns having the smallest cross-correlation value Rᵢⱼ. Such a selection operation is performed by the cross-correlation value comparator 170. A multiplexing gain may increases by using beam patterns having a small cross-correlation value Rᵢⱼ.

In step S150, the reactance information (reactance value or reactance index) for beam patterns selected by the cross-correlation value comparator 170 is stored in the reactance storage unit 180.

In step S160, the reactance control unit 190 controls the reactance of the electrically steerable antenna module 110 according to N reactance information stored in the reactance storage unit 180.

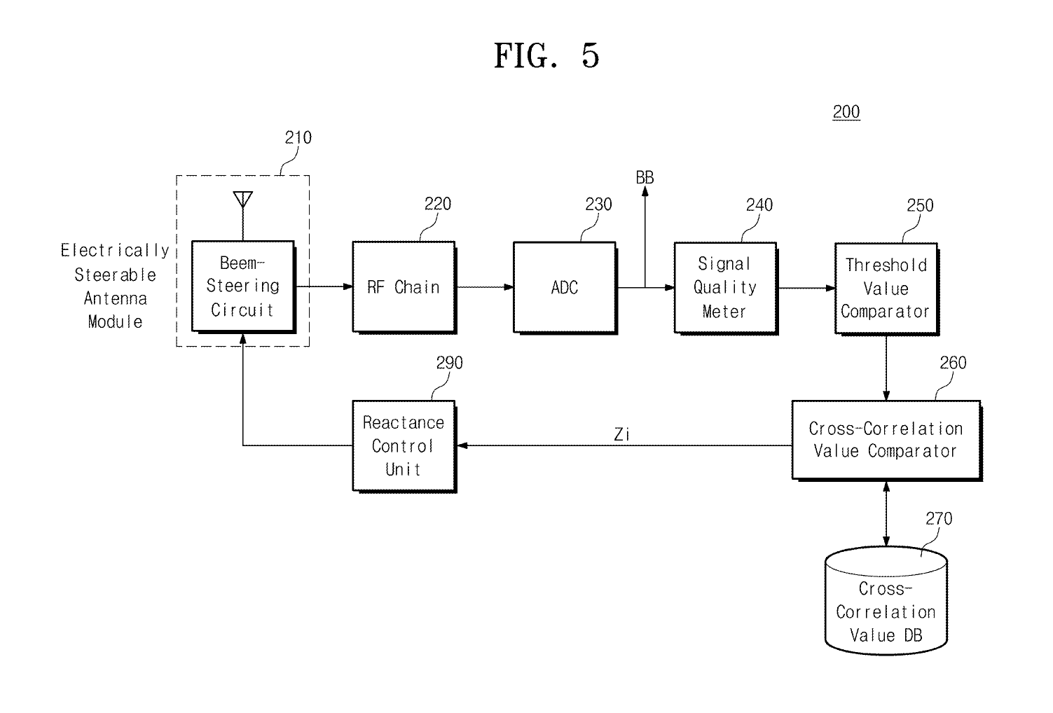

FIG. 5 is a block diagram of a receiver according to another embodiment of the present invention. Referring to FIG. 5, a receiver 200 of the present invention may include the electrically steerable antenna module 210, an RF chain 220, an ADC 230, a signal quality meter 240, a threshold value comparator 250, a cross-correlation value calculator 160, a cross-correlation value comparator 260, a cross-correlation value database (DB) 270, and a reactance control unit 290. In this example, the functions of the electrically steerable antenna module 210, RF chain 220, ADC 230, signal quality meter 240, and threshold value comparator 250 are substantially the same as those in FIG. 1. Thus, their detailed descriptions are omitted.

Firstly, the signal received on each beam pattern is provided to the signal quality meter 240 through the electrically steerable antenna module 210, RF chain 220, and ADC 230. Then, the quality of signal corresponding respectively to beam pattern is measured by the signal quality meter 240, and beam patterns having a signal quality equal to or higher than a threshold value may be selected by the threshold value comparator 250.

Then, the cross-correlation value comparator 260 compares the cross-correlations values between beam patterns having a signal quality equal to or higher than the threshold value.

The cross-correlation values between beam patterns available are calculated and stored in the cross-correlation value DB 270 in advance. Thus, the cross-correlation value between beam patterns selected through the measurement of a signal quality is read from the cross-correlation value DB 270, without additional calculation. Thus, it is possible to minimize a time and cost consumed for calculating the cross-correlation value.

The cross-correlation value comparator 260 reads and compares the cross-correlation value between selected beam patterns from the cross-correlation value DB 270. In addition, the cross-correlation comparator 260 may select beam patterns having a small cross-correlation value. Reactance information corresponding to selected beam patterns is provided to the reactance control unit 290.

The reactance control unit 290 controls the parasitic element of the electrically steerable antenna module 210 based on reactance information corresponding to N beam patterns having a small cross-correlation value. By such reactance control, the electrically steerable antenna module 210 is set to enable the antenna to steer in N beam patterns. For beam-steering, the reactance control unit 290 outputs a reactance control signal LCn for varying the reactance value of the parasitic element.

According to the receiver 200 of the present invention as described above, the received signal qualities corresponding to beam patterns are measured and beam patterns with high signal quality are selected. In addition, the cross-correlation value between beam patterns providing high signal quality may be searched from the cross-correlation value DB 270. Then, beam patterns having a small cross-correlation value are selected. Performing the beam space sampling with beam patterns selected by using this method may provide the maximum multiplexing gain.

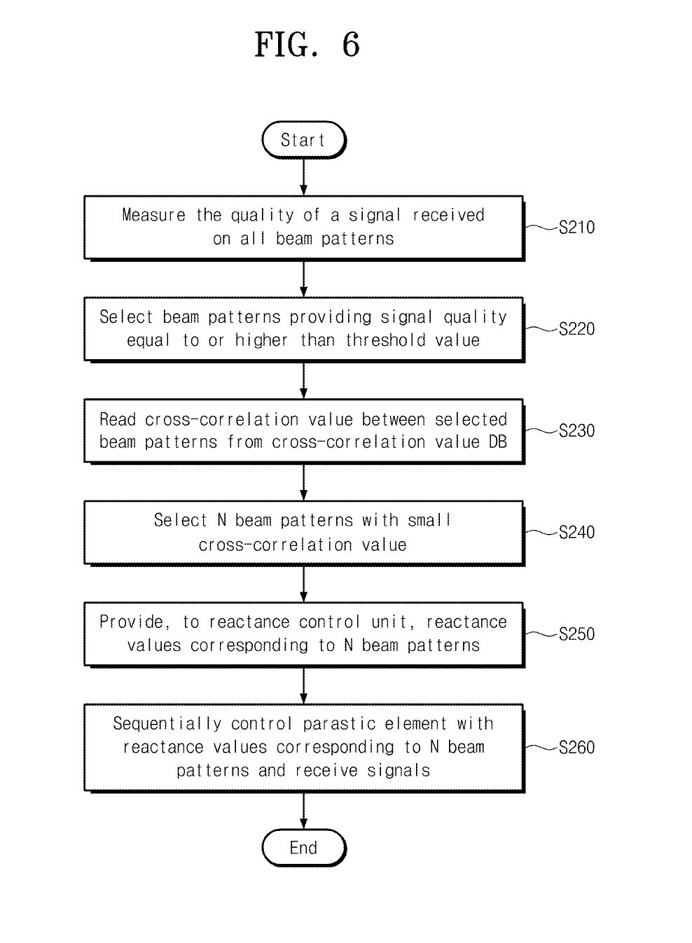

FIG. 6 is a simple flow chart of a beam space sampling method according to the receiver in FIG. 5.

In step S210, the receiver 200 measures the quality of a signal received on all beam patterns. For example, at least one of the magnitude, strength, power, signal to noise ratio (SNR), signal to interference and noise ratio (SINR), and error rate of the signals received from all available patterns are measured by the signal quality meter 240. Firstly, the reactance controller 290 enables the reactance value of the electrically steerable antenna module 210 to be reactance values corresponding to all beam patterns to be measured. By such reactance control, the beam pattern of the electrically steerable antenna module 210 may be configured. The signal quality for each of signals received from respective beam patterns is measured by the signal quality meter 240.

In step S220, the receiver 200 selects beam patterns providing a signal quality equal to or higher than a threshold value.

In step S130, the receiver 200 reads, from the cross-correlation value DB 270, the cross-correlation value between beam patterns selected by the threshold value comparator 250. The cross-correlation value between beam patterns selected by the threshold value comparator 250 is previously calculated and stored in the cross-correlation value DB 270. Thus, the cross-correlation value between the selected beam patterns may be immediately searched for without a calculation process by Equation 2.

In step S240, the receiver 200 selects N beam patterns having small cross-correlation value Rᵢⱼ. Such a selection operation is performed by the cross-correlation value comparator 260. A multiplexing gain increases by using beam patterns having a small cross-correlation value Rᵢⱼ.

In step S250, the reactance setting of each of the beam patterns selected by the cross-correlation value comparator 260 is provided to the reactance control unit 290.

In step S260, the reactance control unit 290 controls the reactance of the electrically steerable antenna module 210 according to N reactance values Zi.

The present invention may provide a multiplexing gain by using only a single active antenna and a single RF chain. Thus, it is possible to provide the multiplexing gain at low power consumption, low complexity, and low cost. In particular, it is possible to provide the multiplexing gain for a user terminal, such as a smart phone, sensitive to a size and power consumption. Also, it is possible to maximize the multiplexing gain by performing optimal beam space sampling through the determination of an optimal beam pattern.

Exemplary embodiments of the present invention have been discussed so far. It is understood by a person skilled in the art that various changes in form may be implemented therein without departing from the essential characteristic of the present invention. Therefore, disclosed embodiments should be considered in descriptive sense only and not for purposes of limitation. The scope of the present invention is defined not by the detailed description of the present invention but by the following claims, and all differences within a scope equivalent thereto are construed as being included in the present invention.

It is obvious to a person skilled in the art that the structure of the present invention may be modified or changed without departing from the scope or technical spirit of the present invention. When considering the descriptions above, it is considered that the present invention includes changes and modifications of the present invention if they are within the scopes of the following claims and their equivalents.

What is claimed is:

1. A beam space sampling method of a receiver comprising an antenna comprising an active element and at least one parasitic element, the beam space sampling method comprising:
varying a reactance value of the parasitic element to receive RF signals corresponding to beam patterns;
measuring the quality of the received signal corresponding respectively to the beam patterns; and
selecting beam patterns providing the signal quality equal to or higher than a threshold value.

2. The beam space sampling method of claim 1, further comprising selecting a specific number of beam patterns with reference to a cross-correlation value between selected beam patterns, or between received signals corresponding to selected beam patterns.

3. The beam space sampling method of claim 2, wherein the specific number of beam patterns correspond to beam patterns of which the cross-correlation values are equal to or smaller than a reference value.

4. The beam space sampling method of claim 2, further comprising sequentially setting a variable reactance of the parasitic element to reactance values corresponding respectively to beam patterns

5. The beam space sampling method of claim 2, further comprising calculating a cross-correlation value between selected beam patterns to select the specific number of beam patterns.

6. The beam space sampling method of claim 2, further comprising calculating a cross-correlation value between received signals corresponding to selected beam patterns to select the specific number of beam patterns.

7. The beam space sampling method of claim 2, further comprising reading, from a cross-correlation value database (DB), a cross-correlation value between selected beam patterns to select the specific number of beam patterns.

8. The beam space sampling method of claim 7, wherein the cross-correlation value DB comprises cross-correlation values between beam patterns.

9. The beam space sampling method of claim 1, wherein the signal quality of the received signals comprises at least one of a magnitude, strength, power, signal to noise ratio (SNR), signal to interference and noise ratio (SINR), and error rate of each of the received signals.

10. A receiver comprising:
an antenna comprising an active element and at least one parasitic element having a variable reactance;
a single radio frequency (RF) chain demodulating the received signal;
a signal quality meter measuring a signal quality of a demodulated signal; and
a threshold value comparator selecting beam patterns corresponding respectively to the received signals with a signal quality equal to or higher than a threshold value.

11. The receiver of claim 10, further comprising a cross-correlation value comparator selecting a specific number of beam patterns with reference to a cross-correlation between the selected beam patterns, or between received signals corresponding to selected beam patterns.

12. The receiver of claim 11, further comprising a reactance control unit sequentially setting a variable reactance of the parasitic element to reactance values corresponding respectively to the specific number of beam patterns to receive RF signals corresponding respectively to the specific number of beam patterns.

13. The receiver of claim 11, further comprising a cross-correlation value calculator calculating a cross-correlation value between the selected beam patterns.

14. The receiver of claim 11, further comprising a cross-correlation value calculator calculating a cross-correlation value between the received signals corresponding to the selected beam patterns.

15. The receiver of claim 11, further comprising a cross-correlation value DB providing a cross-correlation value between beam patterns.

16. The receiver of claim 11, wherein the reactance control unit sequentially sets reactance values corresponding to beam patterns.

17. The receiver of claim 11, wherein the variable reactance comprises at least one of a variable inductor, variable capacitor, switching diode, and micro electro mechanical system (MEMS) switch.
